(19) United States
(12) Patent Application Publication
(10) Pub. No.: US 2016/0325472 A1
(43) Pub. Date: Nov. 10, 2016

(54) FOAM PARTICLES, METHODS OF MAKING AND USING THE SAME

(71) Applicant: LIFOAM INDUSTRIES, LLC, Hunt Valley, MD (US)

(72) Inventor: Saumitra BHARGAVA, Clarksville, MD (US)

(73) Assignee: LIFOAM INDUSTRIES, LLC, Hunt Valley, MD (US)

(21) Appl. No.: 14/705,521

(22) Filed: May 6, 2015

(51) Int. Cl. B29C 44/02; B29C 47/00; B29C 44/34; B65D 81/02; C08J 9/18

(52) U.S. Cl. CPC B29C 44/02; B65D 65/44; C08J 9/18; B29C 44/3461; B29C 47/0011; B29C 47/0066; B65D 2565/381; B29K 2905/02; B29K 2067/046

(57) ABSTRACT

A method of making foam beads, dies to make such beads, the resultant beads, and molding methods and molded articles utilizing such beads. A method of forming polymer foam beads is described by forming a plastic melt of a polymer, adding a blowing agent to the melt to form a polymer-blowing agent mixture, forcing the mixture through a capillary die, and pelletizing the mixture as it exits the die. The capillary die has a non-circular cross-section and shorter length than conventional circular cross-section dies, while maintain the same pressure drop across the die, resulting in polymer foam beads with very thin walls and substantially uniform expansion properties.

### TECHNICAL FIELD

The field of art to which this invention generally pertains is methods for making foam particles.

### BACKGROUND

There are many processes that can be used and have been used over the years to produce foamed articles. While foamed articles have many advantages over their non-foam counterparts, such as using less material, lighter weight to transport, etc., they still use a significant amount of energy to produce, and can also raise environmental concerns for a variety of reasons.

The systems described herein meet the challenges described above, and can provide additional advantages, such as unique materials, and more efficient and effective manufacturing processes.

### BRIEF SUMMARY

A method of forming polymer foam beads is described, including forming a plastic melt of the polymer, adding a blowing agent to the melt to form a polymer-blowing agent mixture, forcing the mixture through a capillary die, pelletizing the mixture as it exits the die, wherein the capillary die has a non-circular cross-section resulting in polymer foam beads with very thin walls and substantially uniform expansion properties.

Additional embodiments include: the method described above where the length of the capillary die is 50% or less than the length of a conventional circular cross-section die; the method described above where the pressure drop across the capillary die is substantially the same as a capillary die with a circular cross section; the method described above where the capillary die has tri-lobal cross section; the method described above where the capillary die has quadra-lobal cross section; the method described above where the capillary die has dendritic cross section; the method described above where the blowing agent is a physical or chemical blowing agent; the method described above where the blowing agent is nitrogen or carbon dioxide; the method described above where the polymer comprises homopolymers, graft polymers, or copolymers of polylactic acid, polystyrene, polyethylene terephthalate, thermoplastic polyurethane, polyvinyl chloride, polyethylene, polypropylene, or mixture thereof; and the method described above where the polymer comprises polyethylene and/or polypropylene copolymers.

An expanded polymer foam particle is also described having a thin skin and uniform expansion properties.

A molded article is also described made up of expanded polymer particles having a thin skin and uniform expansion properties having low density, improved mechanical properties, and cushioning properties suitable for protective packaging; an embodiment where the article is a foam cooler or shipping container is also described.

A method of making a molded article is also described including adding expanded polymer beads having thin skins and uniform expansion properties into a mold, pressurizing the beads, heating and cooling the beads, to produce a molded article in less time and utilizing less energy than conventional molding.

A capillary die specifically adapted for producing foam particles is also described where the capillary die has a non-circular cross-section and a length 50% or less than the length of a conventional circular cross-section die.

Additional embodiments include: the capillary die described above where the capillary die has a tri-lobal cross section; the capillary die described above where the capillary dies has a quadra-lobal cross section; the capillary die described above where the capillary die has dendritic cross section.

These, and additional embodiments, will be apparent from the following descriptions.

### BRIEF DESCRIPTION OF THE DRAWINGS

FIG. 1 is a flow chart of a typical process for forming foam beads and molded articles described herein.

FIG. 2 is a schematic of a typical apparatus useful for forming beads as described herein.

FIG. 3 is a schematic of a typical capillary die system described herein.

FIG. 4a show a cross-section of a conventional capillary die, and FIGS. 4b, 4c and 4d cross-sections of capillary die embodiments described herein.

FIG. 5 is a perspective, schematic view of a conventional and capillary die embodiments described herein.

FIG. 6 shows a cross-section of an embodiment of a capillary die described herein.

FIGS. 7A and 7B show representations of conventional beads and beads described herein before and after expansion.

FIGS. 8A, 8B, and 8C shows representations of loose beads before and after molding.

FIGS. 9, 10 and 11 show the surfaces of articles molded from foam beads.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

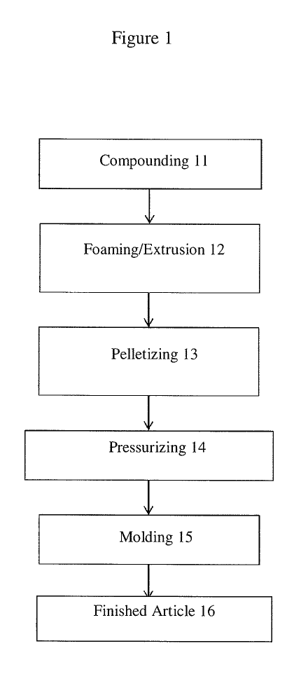

FIG. 1 shows a summary of steps useful for creating a finished article using compositions and processes described above. First, raw materials such as PLA polymer, nucleating agent, and other additives are compounded (11). The raw materials may also be compounded in a separate extruder if desired. Next, a blowing agent, such as conventional supercritical CO₂, is added to the admixture (12). Foamed beads are produced by hot face pelletization of extruded foamed strands at the extruder die face (13). The foamed beads may be cooled using a water bath or other appropriate method. The foamed beads are then pressurized to promote secondary expansion in the mold for the desired end product (14). Such pressurization of the foamed beads will typically be done in conventional manner with a gas such as air, CO₂, N₂, hydrocarbon, etc. For example, the mold containing the beads can be filled with gas and heated (or preheated) to cause the gas to enter the beads Then, the beads are put into a mold to form a selected product (15). A steam press may be used for molding. The beads are expanded in the mold to create a finished product (16).

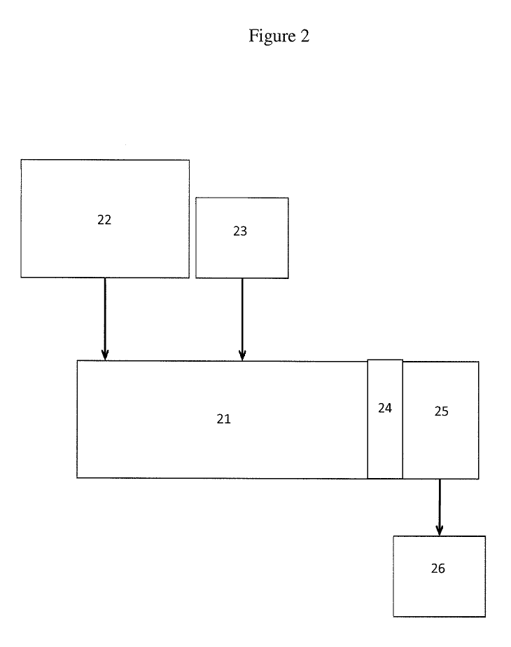

In the extrusion foaming apparatus as shown, for example, schematically in FIG. 2, and, as similarly described for example in commonly assigned Published U.S. Patent Application No. 2012/0007267 and Published U.S. Patent Application No. 2012/0009420, the disclosures of which are herein incorporated by reference, the temperature of the extruder 21 is controlled to allow for melting and mixing of the polymer containing solids 22, and reaction with any chain extension agents or other additives if present, mixing with a blowing agent 23, for example CO₂, and cooling of the melt mixture prior to extrusion through the die 24. For example, since the CO₂ is very soluble in the polymer melt, use of the extruder/mixer results, especially with conventional PLA (polylactic acid) polymers, in very uniform dissolving of the CO₂ into the polymer as well. The temperature of the initial sections of the extruder 21 allows for melting and mixing of the solids, including the dispersion any nucleating agent present within the melt. After injection of the blowing agent 23, conventional mixing elements are used to mix the blowing agent with the melt. The soluble blowing agent within the melt plasticizes the melt reducing its viscosity. The plasticization effect allows for the cooling of the melt to below the normal melting temperature of the polymer in the final sections of the extruder 21. The cooling increases the viscosity of the plasticized melt, allowing for retention of a closed cell structure during foaming at the die.

As mentioned above, the blowing agent can be any physical or chemical blowing agent typically used in foam processes, including CO₂, butane, liquid butanol, nitrogen, etc.

As extrudate exits the die 24 and is foamed, rotating knives of the pelletizer 25 cut the bead at the face of the die. When cut, the foam is not completely finished. The foaming process continues to shape the structure of the bead after it has been cut. The blowing agent continues to evolve, typically expanding the particle 3 to 6 times the diameter of a round capillary. The outer skin of the particle remains rubbery while cut, allowing the surface of the foamed bead to flow and reform a smooth, solid surface. A multi-blade pelletizer 25 is typically mounted to the extruder 21 and die 24 assembly. The resulting foamed beads 26 are typically first cut at the face of the die 24 with the pelletizer 25 operating at, for example, 1500 to 2500 rpm. Conventional underwater pelletizers, available from Gala Industries, for example, can also be used to produce the beads as described herein. With water surrounding the beads as they are formed rather than air surrounding the beads, typically rounder beads can be generally formed.

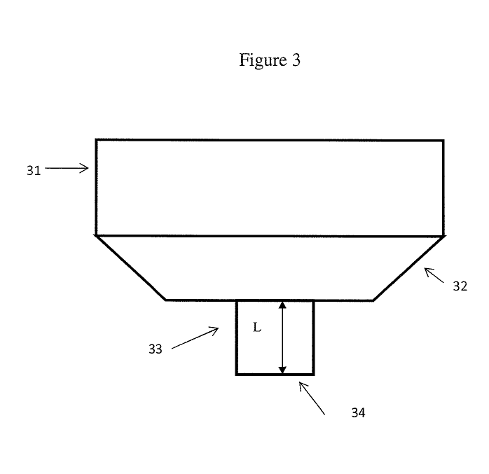

Typically processes which can be used to generate the capillary dies described herein are those, for example, similar to those described in U.S. Pat. No. 3,868,870, the disclosure of which is herein incorporated by reference. In general (see FIG. 3), counterbores (32) are formed in a spinneret plate (31), a countersink (33) is punched or otherwise formed in the bottom of each counterbore to a preselected depth of penetration, and the capillary formed in the bottom (34) of the countersink (typically paper thin) by punching, laser cutting, electrical discharge machining, etc. As discussed in more detail below, there is a lower limit to how thin L can be because of the back pressure produced in use to form the beads, and the stress this causes on the joints, e.g., between sections 31 and 32, and 32 and 33, and premature foaming activity which can take place if L becomes too thin. There is an upper limit as well based on the ability of conventional laser or wire processing to be able to cut the holes, among other things. The capillaries described herein are typically about 1 mm (millimeter) to about 4 mm in length, and conventional capillaries can be up to about 10 mm in length for a typical 0.5 to 1.5 mm diameter capillary.

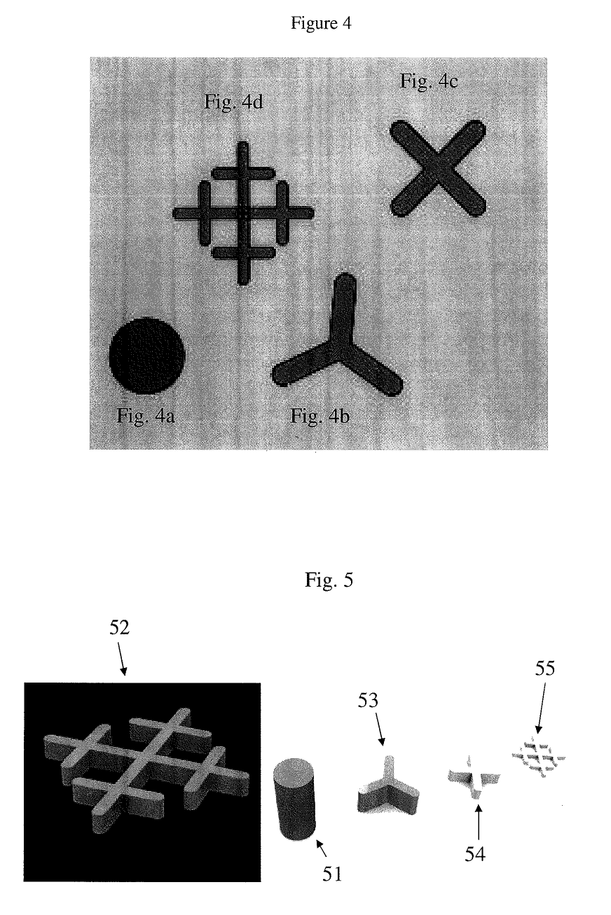

FIG. 4 shows the cross-section of a conventional capillary die (4a) used to make foam particles, and exemplary cross-sections of capillary die embodiments described herein (4b, 4c and 4d). The cross-sections all have the same opening surface area, but the capillary die embodiments described herein produce thinner wall surfaces as described herein.

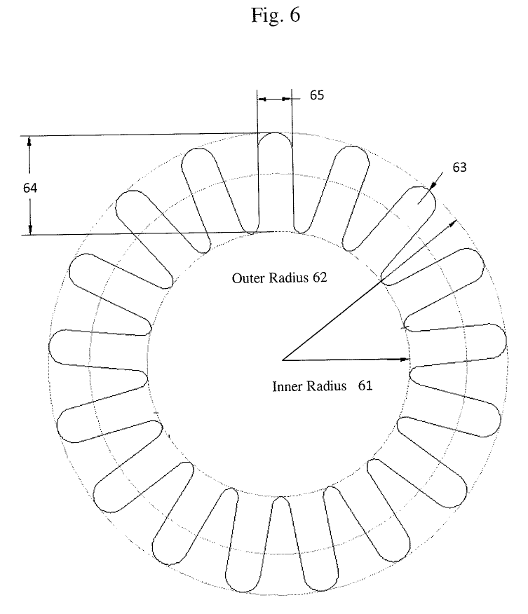

FIG. 5 shows perspective, schematic views of a conventional capillary die (51) used to make foam particles, and exemplary capillary die embodiments described herein (52, 53, 54, and 55). By modifying the depth of the capillary, one can obtain the same pressure drop and same output per capillary. Note the depth of the tri-lobal (53), quadra-lobal (54) and dendritic (55) are much shallower vs. the round capillary but will produce the same pressure drop and output, but thinner walls on the foam particles. An expanded view of the dendritic capillary shown (55) is a representative cross-section, as stated above, which provides thinner walled particle foam. For the same pressure drop across the capillary, a much lower depth is needed with these alternate cross-sections compared to the circular cross-section. Despite the unusual shapes, the particles obtained from this capillary are substantially cylindrical when produced by foam strands extruded in air. Note, the underwater pelletization is expected to produce more spherical shape.

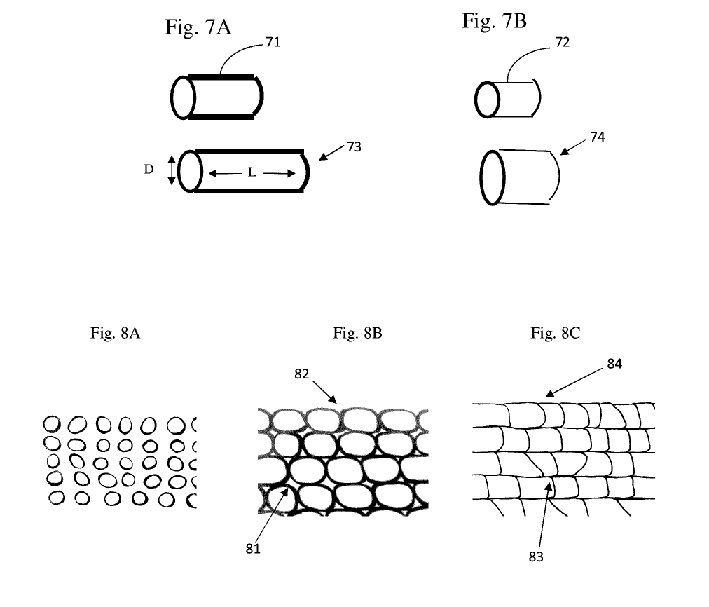

In FIG. 6, an exemplary capillary die or spinneret useful in the processes described herein is shown, having an exemplary inner radius 61 of 0.42 mm (millimeter); outer radius 62 of 0.73 mm; tip radius 63 of 0.028 mm; tip length 64 of 0.16 mm; and tip width 65 of 0.055 mm. It should be noted that the process described herein is not limited to these specific exemplary dimensions, but the use of these relative dimensions can provide the benefits and advantages described herein. For example, the die can be made bigger or smaller, and can typically have an outer diameter of 1 mm to 1.5 mm.

As mentioned above, the actual size of the die is not critical, but will depend on the size of the particle desired and the particular part to be molded. For some molding applications it may be desired to produce and mold larger rather than smaller beads.

As described herein, while benefits associated with the thinness of the walls of the foam beads produced contributes to the energy savings, shorter cycle time, improved properties etc. of the foam beads and articles produced, it is difficult to measure the exact thinness of such walls. Typically wall thickness is measured using electron microscope. However, in measuring such wall thickness of the particle, the particle is actually destroyed in the process. For example, the use of an electron high tension voltage of 8 to 15 kV will disintegrate the side face within a second while 25 to 30 kV disintegrates the thicker cylindrical wall in a second. Using this indirect measure, it is estimated that the thinner walls are less than half as thick as the walls in a conventionally formed bead. This results in a bead that expands significantly more with the same internal pressure, e.g., 50% to 80% higher. This is akin to a balloon with a thicker wall—with the same pressure exerted internally, it would not expand nearly as much.

The use of the die such as shown in FIG. 3, increases the contact surface of the polymer to the metal, ceramic, ceramic coated metal, etc. or whatever material which is typically being used to produce the die. Typically, the beads produced by the apparatus shown in FIG. 3 are cylindrical or disk-like in shape, and often longer than they are wide. But independent of the specific shape produced, the skin surface on the pellets produced in the past is also typically non-uniform, e.g., thicker on the cylinder or disk portion than on the ends. As a result, the particle, or bead expands non-uniformly when forming a molded article, for example, the ends expanding more quickly than the rest of the body of the bead.

Utilizing the dies described herein, not only is a thinner skin generated on the beads or particles, but the thickness of the skin is more uniform around all sections of the particle, regardless of the ultimate bead shape produced. And in the particular embodiments shown in FIGS. 4b, c and d, for example, if a length approximating the diameter of the bead is produced depending on the speed of the spinning blades for example, this can have additional advantages in the subsequent article molding process as well.

Foam coolers and shipping containers (e.g., for personal and medical protective packaging, as well as for shipping fish and produce, computer related items, etc.) are some examples of articles that can be produced using the beads and processes described herein. In fact, using the beads described herein can result in thinner packaging with at least the same properties.

The ability to produce a thinner skin on the bead results in many advantages, especially in subsequent bead molding. For example, in a typical bead molding process, during processing, at least some of the CO₂ escapes from the bead, leaving partial vacuum within the bead. Subsequent processing of the bead cannot happen until air diffuses in the bead to replace vacuum. Thinner wall beads allow shorter wait times before the next processing step. Also in a typical mold processing step, the bead-filled mold is filled with air under pressure, filling in these voids. With the beads as described herein, independent of the shape or size of the particle produced, the thinner wall allows all of this processing to happen much faster.

In a typical process as described herein, the beads exiting the die can have a size of about 1.5 mm, for example. Because, as a result of the processing described herein, they are still expanding, the beads will continue to expand, for example, to a size of about 3 to 6 times greater than the capillary diameter (depends on capillary shape) as they are formed and chopped by the spinning blade. Regardless of the shape described in FIGS. 4a-d, the size of the bead as the open area and linear velocity of polymer flow is identical in those shapes. With this type of processing, as described above, the beads produced typically have a log or cylinder-like shape, with the size as they come out of the die expanding very quickly. Since they are chopped directly as they come out of the die, blade speed determines length of log or cylinder-like particle as it comes out of the die.

The process described herein produces a more uniform skin, and particles with a more uniform size distribution as well. All of these properties contribute to improved molding properties, such as improved and faster pressuring, cycle time, mechanical properties, etc. as well as improved properties in the ultimate molded foam article produced. For example, in the air pressuring step described above, it should take less energy to perform this step because the walls are thinner, the particles more uniform, it will take less time to pressurize, heat, and cool the beads, etc.

Pressure drop in non-circular pipes or capillaries can be approximated by using hydraulic diameter vs. diameter of a circular pipe in pressure drop calculation for a capillary. A hydraulic diameter is defined as 4 times the cross-section area of the capillary divided by the wetted perimeter. The concept behind the cross-section shown in FIG. 6 is evident as the added undulations increase the wetted perimeter resulting in a smaller hydraulic diameter vs. the round capillary. This smaller hydraulic diameter in turn increases the pressure drop across the capillary opposite a capillary with a round cross-section with equal area. To maintain the same open area and pressure drop for a given polymer melt, reduced capillary depth ensures equal pressure drop.

The dies typically are about one-half inch thick, typically made of metal or other material typically used to make capillary dies and spinnerets, with the sub-micron features, opening and side-walls, as described herein. They can be obtained from Nippon Nozzle, Kasen Nozzle, Ceccato Spinnerets, Invista Precision Concepts, Enka Technica etc., for example.

In addition to the shapes shown in FIGS. 4b, c and d, and FIG. 5 (52 through 55) and FIG. 6, other shapes, inner diameters, and outer diameters which accomplish the same result in the bead formed can be used. For example, a star shaped opening can theoretically produce the same result. The die openings as described herein can be produced with conventional wire electric discharge machining, punch electric discharge machining, or laser cutting for example, to produce micron resolution in a plate which is 1 inch or more thick, for example. One benefit of rounded corners as shown in FIGS. 4, 5 and 6, versus star shaped corners, for example, is that the polymer can flow more easily through the rounded corners of the pedal, vs. the sharper corners of the star, which would provide more efficient and effective processing when forming the beads described herein

In addition to using conventional PLA polymer materials to make the improved foam beads, other conventional polymer materials can be used as well to produce foam beads as described herein, such as EPS (expandable polystyrene), EPP (expandable polypropylene), EPE (expandable polyethylene), EPET (expandable polyethylene terephthalate), EPVC (expandable polyvinyl chloride), and ETPU (expandable thermoplastic polyurethane), and mixtures, homopolymers, graft polymers and copolymers thereof, for example. And while polymers useful with the methods and systems described herein can have any glass transition or melt temperature, examples of polymers useful as described herein can have glass transition or melt temperatures between about 50° C. and about 95° C., or higher, for example, eTPU (expandable thermoplastic polyurethane) can have a melt temperature of about 170° C., and polypropylene a melt temperature of about 170° C. and a glass transition temperature (Tg) of less than about 10° C. See also, commonly assigned, copending U.S. Patent Application No. 62/084,839 entitled “Method of Making Foam Articles”, the disclosure of which is herein incorporated by reference.

As stated above, not only can the beads produced by the process described herein mold much faster, at lower temperatures, with less energy, but they also can produce improved properties in the finished molded product, such as lower density, improved tensile strength and flexural strength in the molded part, etc.

As described above, the invention described herein can work with any shape of pellet. While the pellets are typically formed in rod or cylindrical shapes, they can be spherical, disk, or ellipse in shape. Because of the thinner skin produced by the process described herein, the beads as produced are typically formed in a more spherical than cylindrical shape.

Typically, the dies described herein will have a multiple number of holes, e.g., 10 to 72 holes, at the point where the blade is cutting the polymer to form the beads. Each die or spinneret hole is machined separately. While the hole in the die is quite small, because of the blowing agent, e.g., CO₂ dissolved in the polymer, the bead expands very quickly to form a much larger bead, e.g., about 2 to about 5 mm, or more.

While the cross-section of the bead forming holes in the die historically have been circles, the holes in the dies as described herein are in a petals or flower shaped, for example, as shown in FIG. 6, containing smooth curves on the petals, and containing as many as 70 petals for example. Accordingly, the hydraulic diameter of the die is different. The polymer during bead formation will be touching more surface, the hydraulic diameter, and accordingly will foam very differently, resulting in thinner walls on the beads and more uniform expansion of the foam particle. Among other things, this will result in much easier processing of the beads, using much less energy, reduced wait time prior to pressurization, and very thin walls compared to other bead foam materials. Because of the particular shape shown in the figures, the extensions shown are referred to as petals. However, they can also be referred to as arms, legs, spokes, etc. See, for example, U.S. Pat. No. 3,868,870, cited above.

With thinner walls, everything can happen very quickly. With less water and less air in the beads, for example, expansion happens much more quickly. For example, beads can be pressurized in ¼ to ⅛^{th} the time and the articles can be molded with 20% or less of the energy typically required, by changing this cross-section profile of the spinneret hole.

As stated above, the beads expand with very little energy input because the walls are so thin, can expand a lot more and faster with less energy during processing. Because the bead walls are so thin, the beads can expand and contract very quickly. For example, when beads described herein are put in a tank, and the air pressure is increased until air diffuses into the beads. 30 psi for 12 hours is the normal pressure typically required to expand the beads, where here with the beads described herein, expansion can take place even at 20 psi for 1 hour.

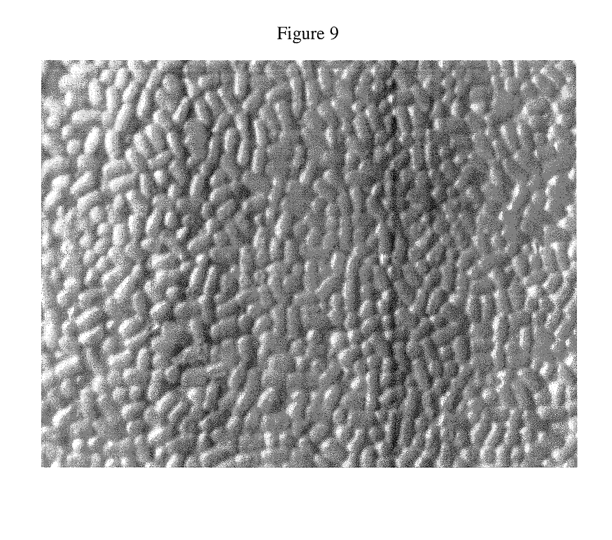

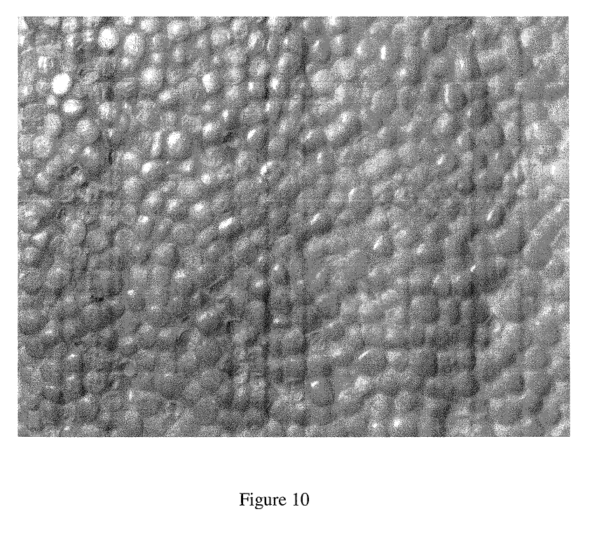

As particles are formed coming out of the capillary die, as represented in FIG. 7, they are significantly different in size and shape as they emerge from conventional dies (FIG. 7a), as opposed to with the modified dies described herein (FIG. 7b). Beads formed with conventional dies have much thicker walls (71). Because of the thinner walls (72) formed by the dies described herein, the thinner-walled beads expand much more easily against the mold surface than do beads with thicker walls. As shown in FIG. 7, the thicker-walled beads also expand (73) less uniformly than the thinner-walled beads (74), the thicker walls causing greater expansion lengthwise (L) as opposed to across the diameter (D) as compared to the thinner walled beads. As a result, the thicker-walled beads generate a molded surface which appears beady, and contains gaps, and pockets. The thicker walled beads also take more energy to get them to fuse together. As demonstrated in FIG. 8, with their thinner walls, the bead surface (84) can conform more closely to a mold wall, producing a smoother surface, filling in a majority of the voids (81), which would otherwise occur, much more easily (83). In addition to a far less grainy appearance and feel, the thinner-walled beads produce molded products with far superior mechanical properties, e.g., because beads can deform around each other and intertwine and interlock both more easily and more extensively. This also produces additional benefits, e.g., in the areas of pressurization and molding, as demonstrated in the Table below. For example, with a circular cross-section die as shown in FIG. 4a, it is necessary to pressurize beads at 30 psi (pounds per square inch) for 12 hours following by molding at a temperature of 95° C. (centigrade) to get a relatively smooth surface. At lower pressure it is necessary to heat the beads longer to allow the beads to fuse and lock, and allow the gases inside to expand. With the thinner-walled beads described herein, it takes less energy and less pressurization, to produce a molded part with a much smoother appearance—with improved mechanical properties.

TABLE
Pressurization/Molding Combinations

| | | | Maximum | |
|---|---|---|---|---|
| | Pressurization | Pressurization | Mold | |
| | Pressure | Time | Temperature | |
| Process | PSI | Hours | ° C. | Results |
| Standard | 30 | 12 | 95 | Non-beady |
| | | | | surface |
| Standard | 20 | 12 | 102 | Beady |
| | | | | surface |
| | | | | with gaps |
| Modified | 30 | 12 | 92 | Beads burst |
| Modified | 30 | 8 | 95 | Beads burst |
| Modified | 30 | 2 | 92 | Smooth |
| | | | | surface |
| Modified | 20 | 2 | 92 | Smooth |
| | | | | surface |

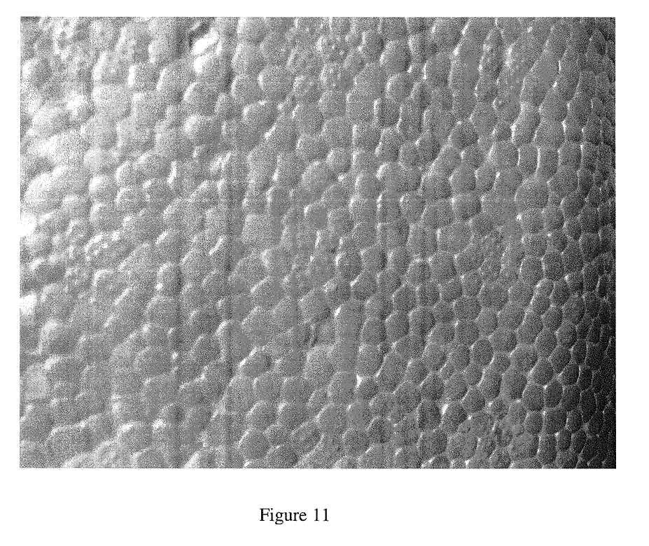

As can be imaged, it is of great cost, time, etc. advantage for pressurization time to be reduced. For example, pressurization tanks represent a significant cost associated with molding of the beads into usable parts. If pressurization time can be reduced, from 12 hours to 2 hours, for example (see Table above), capital cost for equipment could be potentially reduced by 40 to 45 percent. In addition, surface properties of the molded parts are improved as well. See, for example, FIGS. 9, 10 and 11, demonstrating the beady and non-beady nature of the different molded surfaces, where FIG. 9 shows a beady surface, FIG. 11 a smooth thin walled surface, and FIG. 10 a thin walled surface where the beads have burst and collapse.

Using conventional underwater pellitization, can produce more spherical looking beads as the water allows end of the cylinders to bow further. But in any case, the beads actually still look more like strands with extrusion and blade cutting. What is actually being produced is stout cylinders with bulging ends or stout capsules. The wall thickness on face is much thinner than on the length, so on expansion, the cylinder expands even more. Scanning electron microscope electron high tension voltage is the only (relative) measure which has been used for detecting the difference in wall thickness. The act of measuring destroys the sample. But in any case, on expansion the cylinder elongates more than the diameter expands.

Because of the thinner walls, the beads expand more evenly, producing parts with better mechanical properties. The tensile strength is a lot higher, and the yield strength is a lot higher, so the molded part can't be pulled it apart so easily, because the beads interlock to a certain extent upon molding. See, for example, FIG. 8 showing representations of loose particle foam before molding (FIG. 8a), and conventional foam particles (FIG. 8b) and foam particles as described herein (FIG. 8c) after molding. As demonstrated by the figures, the conventional particles contain spaces (81) and a rougher surface (82) than the molded article produced with the particles described herein, containing fewer spaces (83) and a more interlocking particle result, as well as a smoother surface (84).

The thicker walls along the sides vs. the face in the beads formed with conventional capillary dies is generally associated with residence time in the capillary. As shown in FIG. 3, the walls in the countersink (33) cannot generally be machined completely straight, e.g., containing a 1 to 2 degree taper, but this won't generally show up on drawings/blue prints. The foam polymer moves faster in middle of capillary than on the sides, based on general fluid mechanics. So the sides of the particle formed become thicker because of freer flow in the middle. The capillary wall is causing the thickness. So if the wall height/length can be reduced, the bead walls will become thinner. The problem with shortening L (by 50% for example), the dissolved gases will come out too soon with L too short. CO₂ and other gases are dissolved in the polymer. As you get closer to the opening, there is less pressure on the polymer solution, so the CO₂ starts to come out. Bubbles start to form. If L is shallow enough, foaming starts to happen further away from the capillary opening, which can cause obvious problems. For example, larger foaming can occur closer to the opening, and polymer flow gets modified, and polymer “spitting” can occur, with CO₂ bubbles forming too early.

So the longer the L (capillary length), the greater the pressure drop, which keeps the CO₂ dissolved in the polymer longer. However, by changing the shape of the capillary as shown herein, the pressure drop can be increased without increasing the length of the capillary, and the more petals inserted, the greater the pressure drop per unit of length. So the desired pressure drop can be maintained, but the length of the capillary can be shorted. So the minimum pressure drop required to get a steady state flow can be maintained while a desirable shortening of the length of the capillary can be employed, resulting in thinner walls and the advantages described herein. The longer the length of the capillary, the thicker the walls produced. As described herein, the requisite back pressure to keep the CO₂ in solution can be maintained with shorter length capillaries, resulting in thinner walls in the beads, i.e., wall thicknesses closer to face thicknesses.

By decreasing the capillary length, thinner bead walls are produced. But decreasing the length, decreases the pressure drop, which can cause foaming within the counterbore, which causes problems in flow, etc. Uneven flow changes polydispersity, which can cause polymer sputter and spit out, process flow harder to control, etc. But by changing the cross section shape of the capillary, the same pressure drop with a shorter length or height capillary can be attained.

This technology is extremely useful for EPP and ETPU. These materials are particularly useful in the automotive industry, where lighter materials are desired, e.g., bumpers, seats, headrests, etc. But processing times for ETPU and EPP molded parts can be relatively long, e.g., 3 to 10 minutes. Processing with the beads described herein, can cut down processing time for these materials significantly, including a significant change in temperature of steaming. See the Table for example. Processing time of ETPU for use in shoes, for example, can also be significantly reduced, making this product less expensive to produce. In addition to processing advantages, a thinner bead wall is produced, which produces better mechanical properties in the finished product, with smoother surface properties as well.

As described, the pressure drop in the capillary is the same as with conventional circular cross section capillaries. A cross section is selected which results in the same pressure drop, and causes foaming to begin at the same spot, while decreasing the capillary length. Decreasing the capillary length, while maintaining the pressure drop, allows nucleation and foaming to happen at the same location in the bead forming capillary system, but with thinner walls produced in the beads. A uniform, homogeneous molten polymer with dissolved gases undergoes heterogeneous nucleation. A nucleating agent such as talc is generally added. As soon as the pressure drops below a threshold pressure, 600 psi to 1000 psi for example, start to see CO₂ phase separation from liquid to gas. Bubbles of CO₂ begin to nucleate from liquid to gas in the polymer melt in the capillary. The capillary design provides a gradual pressure change allowing foam development in a controlled fashion.

Normally nucleation and foam formation begins in the capillary, but if the length of the capillary gets too short, process control and uniformity of the beads becomes a problem. Decreasing the capillary length but maintaining the pressure drop, is accomplished by choosing a particular cross section as described herein, producing polymer foam beads with very thin walls. While any cross sectional shape may be selected which accomplishes this objective, the tri-lobal shape (FIG. 4b) is particularly effective in this regard. It should also be noted that well defined cylinders (FIG. 7) or cylinders at all for that matter, may not be formed with the process described herein, but because of the thinness of the walls produced, their superior ability to deform on molding causes interlocking, which also improves mechanical properties of the molded product.

Capillary length as described herein can be reduced by 50% or more while still maintaining the requisite pressure drop to form the foam beads, while attaining the thinner walls desired. In order to get the foaming in the capillary as opposed to up in the counterbore, the length can be reduced by more than half with enough petals in the capillary—as long as the requisite pressure drop is maintained. For example, for a given polymer at a defined temperature, with a capillary length of 3 mils (0.076 mm), pressure drop for a given diameter could be 200 psi with circular capillary cross section, but with tri-lobal, for the same length, pressure drop could be 800 psi. Accordingly, the length could be decreased from 3 mils (0.076 mm), to 1.5 mil (0.038 mm), to 1 mil (0.025 mm), or shorter in length with the tri-lobal cross section and still maintain a satisfactory pressure drop by changing the cross-section shape of the capillary. In addition, the change would result in thinner walls in the beads produced, with the benefits described herein. Modifying or adjusting the capillary cross-section can allow reduction of capillary length to ⅓ the length or more, a ⅔ reduction, while maintaining the desired pressure drop.

Pressure drop which is desired in the capillary will depend on polymer being processed, what the dissolved gases are, the density trying to be achieved, etc. For a particular die, there may be 60 of these capillaries, more, or less. Since measuring the pressure drop changes the flow, it is typically measured relatively far above where the flow is, and is then typically computed. Representative pressure drops in a typical bead forming process can be as low as 150 psi, and as high as 400 psi or more—800 psi, for example.

It should be noted that as a result of the thinner walled beads, conventional molding machines can be utilized, utilizing less energy, and taking less time to mold a particular article. In some cases, lower steam pressure machines like conventional EPS machines may be suitable replacement for expensive higher pressure EPP machines.

Because of the thin skin as described herein, the beads interlock better during molding. This provides for more uniformity, not only within the molded article, but the surface appearance as well. The beads expand more uniformly to fill the gaps. The conventional cylinder shape is also not visible with the more uniform expansion produced with the beads described herein. For example, with the tri-lobe formed beads, once it expands there is little or no evidence that the bead has any resemblance to a cylinder. Utilizing the conventional circular cross section capillary, the cylindrical appearance is detectable even after molding.

With bead foam, the smaller the capillary hole, the finer the particle, the stiffer the article, modes of energy dissipation increase, and every bead is much smaller, including a significant change in mechanical properties. Up to now there has been a limit as to how small capillaries can be made (and to some extent how fast the blade can spin)—but with micromachining this is changing rapidly. And with the ability of using capillaries of a shorter length (e.g., less than 1 mil (0.025 mm)), molded articles which are lighter, stiffer, having increased tensile and yield strength over the traditional round cross section capillaries are possible.

### Example 1

A dry mix blend of plastics is produced consisting of approximately 75% by weight of NatureWorks INGEO 80521) polylactic acid (PLA), approximately 15% by weight of Nature Works INGEO 4032D, 7% by weight of GreenDot GDH 919 modified starch elastomer, 2% by weight of Clariant CESA-extend OMAN698498 styrene-acrylic multifunctional oligomeric reactant, and approximately 1% by weight of conventional talc masterbatch (Cereplast ECA-023, for example). The dry mix of pellets is fed gravimetrically into the feed throat section of a twin-screw extruder. The feed rate for the solids is set to 18.1 kg/hr (40 lbs/hr), and the screws rotate at 40 rpm. Supercritical carbon dioxide (CO₂) is injected into the plastic melt at 16 g/min (grams/minute) at a pressure of about 17.2 MPa (2500 psi). An 54-hole die having a cross-section described in FIG. 6 is bolted to the end of the extruder. The die includes an adapter section that adds a heating zone before the die. The melt pressure during operation of the extruder is about 17.2 MPa (2500 psi).

The temperature profile of the barrel sections from feed to exit in the mixer/extruder is systematically adjusted to achieve 190° C., 190° C., 190° C., 175° C., 130° C., 111° C., 111° C., 111° C., 111° C., and 128° C. across the extruder and die. At these conditions, the melt pressure at the die is 14.5 MPa (2100 psi). The extrudate is foamed to a density less than 0.034 g/cm.³ (2.1 lb/ft.³) with a closed cell structure. The surface temperature of the strand extrudate is less than 40° C.

An on-axis, two-blade cutting system (pelletizer), operating at 2600 rpm. is mounted to the extruder and die assembly. Foamed beads are cut at the face of the die. The foamed beads are free flowing and do not stick together. The surface of the foamed beads is complete and does not exhibit open or broken cells. The density of the foamed beads is less than 0.034 g/cm³ (2.1 lb/ft³), and the bead diameter is approximately 3 mm. with a closed cell structure with cell size in the range of 50μ to 100μ.

### Example 2

The foamed beads from Example 1 are pressurized in a sealed vessel using the following pressurization scheme: pressure of 0.07 MPa (10 psi) is applied for 20 minutes, pressure is increased to 0.14 MPa (20 psi) and maintained for 20 minutes, and finally increased to 0.18 MPa (25 psi) and maintained for about 80 minutes. A rapid depressurization of the vessel is performed when foamed particles move to molding machine supply hopper. The beads are conveyed into the cavity of a conventional EPS molding press (Hirsch HS 1400 D) within 15 minutes of removal from the pressure vessel. The machine supply hopper is filled from the pressurization tank every 5-8 shots to minimize variation in foam bead expansion capability during molding. A conventional aluminum mold for expandable polystyrene (EPS) is used in the shape of a box. The following process is used for molding a final product. The mold is filled using conventional fill guns. The first cross steam process is set for 3.1 seconds at 0.65 bar steam pressure and a 90% valve opening. A second cross steam process, reversing the direction of steam flow, is used for 2.9 seconds at a steam pressure of 0.65 bar and a 90% valve opening. The drain is opened to eliminate any potential condensate from mold. 31.0 seconds of vacuum is applied. Vacuum is replaced with air by opening the drain. The molded box is ejected from the press. The shapes of the beads after molding clearly demonstrate secondary expansion of the foamed beads within the mold. Surface depressions and textures from the mold cavity are replicated into the surface of the article. Based on weight and geometry of the box, the density of the molded article is typically about 1.8 lb/ft³.

The processes and materials described herein allow for the conversion of existing EPS manufacturing plants to produce a foamed article based on a compostable or biobased polymer.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of forming polymer foam beads comprising, forming a plastic melt of the polymer, adding a blowing agent to the melt to form a polymer-blowing agent mixture, forcing the mixture through a capillary die, pelletizing the mixture as it exits the die, wherein the capillary die has a non-circular cross-section resulting in polymer foam beads with very thin walls and substantially uniform expansion properties.

2. The method of claim 1, wherein the length of the capillary die is 50% or less than the length of a conventional circular cross-section die.

3. The method of claim 1, wherein the pressure drop across the capillary die is substantially the same as a capillary die with a circular cross section.

4. The method of claim 1, wherein the capillary die has tri-lobal cross section.

5. The method of claim 1, wherein the capillary die has quadra-lobal cross section.

6. The method of claim 1, wherein the capillary die has a dendritic cross section.

7. The method of claim 1, wherein the capillary die has up to 70 petals.

8. The method of claim 1, wherein the blowing agent is a physical or chemical blowing agent.

9. The method of claim 1 wherein the blowing agent is nitrogen or carbon dioxide.

10. The method of claim 1, wherein the polymer comprises homopolymers, graft polymers, or copolymers of polylactic acid, polystyrene, polyethylene terephthalate, thermoplastic polyurethane, polyvinyl chloride, polyethylene, polypropylene, or mixture thereof.

11. The method of claim 1, wherein the polymer comprises polyethylene and/or polypropylene copolymers.

12. An expanded foam particle made by the process of claim 1, having a thin skin and uniform expansion properties.

13. A method of making a molded article comprising adding expanded polymer beads having thin skins and uniform expansion properties into a mold, pressurizing the beads, heating and cooling the beads, to produce a molded article in less time and utilizing less energy than conventional molding.

14. A molded article made by the method of claim 13, comprising expanded polymer beads having a thin skin and uniform expansion properties having low density, improved mechanical properties, and cushioning properties suitable for protective packaging.

15. The molded article of claim 14, wherein the article is a foam cooler or shipping container.

16. A capillary die specifically adapted for producing foam particles, the capillary die having a non-circular cross-section and a length 50% or less than the length of a conventional circular cross-section die.

17. The capillary die of claim 16, wherein the capillary die has a tri-lobal cross section.

18. The capillary die of claim 16, wherein the capillary dies has a quadra-lobal cross section.

19. The capillary die of claim 16, wherein the capillary dies has a dendritic cross section.
